(19) United States
(12) Patent Application Publication
(10) Pub. No.: US 2004/0032335 A1
(43) Pub. Date: Feb. 19, 2004

(54) Accessible smoke/carbon monoxide detector system and apparatus for single/multifamily new residential installations

(76) Inventor: Brent Duane Parrish, Henderson, NV (US)

Correspondence Address: WEISS & MOY PC, 4204 NORTH BROWN AVENUE, SCOTTSDALE, AZ, 85251, US

(21) Appl. No.: 10/218,064

(22) Filed: Aug. 13, 2002

(51) Int. Cl. G08B 17/10

(52) U.S. Cl. 340/628

(57) ABSTRACT

An accessible smoke/carbon monoxide detector (combustion gas detector) apparatus and system aids in preventing alarm system failures and easing maintenance by providing a system that includes a ceiling mounted smoke/carbon monoxide detector and a wall mounted battery compartment including a test switch and a battery charge indicator. Both the wall mounted battery compartment and ceiling mounted smoke/carbon monoxide detector are provided in rated housings that conform to standard electrical box dimensions and specifications. The boxes include apertures for passing wires behind the surface of the ceiling and the wall, providing a permanent installation that does not required unsightly or easily damaged external wiring. The alerting mechanism may be a strobe light or an audible alarm or both, and a separate strobe light fixture is provided for mounting near the ceiling but on the wall where code requirements specify high wall mount installation.

### BACKGROUND OF THE INVENTION

1. Field of the Invention

The present invention relates generally to smoke/carbon monoxide detectors and alarms, and more specifically, to a smoke/carbon monoxide detector and alarm having a battery and controls accessible by persons having a physical disability.

2. Background of the Invention

Ceiling mounted smoke/carbon monoxide detectors (combustion gas detectors or combustion product detectors) are required in all single/multi-family residential buildings. The detectors include an alerting mechanism, which is typically an audible alarm wired to the AC residential power system. For operation in case of a power failure, smoke/carbon monoxide detectors include battery back-up, typically in the form of a 9-volt rectangular battery.

The battery and smoke/carbon monoxide detector are tested by depressing a test switch provided on the smoke detector housing, which causes the alerting mechanism to be activated. Some smoke/carbon monoxide detectors include a strobe light for alerting persons who are deaf or have reduced auditory function to the activation of the smoke detector.

However, the installation of smoke/carbon monoxide detectors at the ceiling level (desirable for detection since heated smoke rises) makes it difficult to activate the test button and/or replace the battery. Installation on cathedral ceilings or ceilings that are higher than 8 feet, make testing and battery replacement impossible without the use of ladders. Furthermore, physically disabled and elderly persons in general are prevented from testing and maintaining smoke/carbon monoxide detectors without special modification.

Smoke/carbon monoxide detectors can be modified to accommodate the physically disabled and elderly persons, but this is typically accomplished by adding unsightly and easily damaged wiring from the smoke/carbon monoxide detector along the interior surface of the ceiling and wall. In general, smoke/carbon monoxide detector designs are packaged in much the same manner as the original add-on devices were packaged, before their installation became a requirement in residences. There has long been a need for an easily maintainable and unobtrusive smoke detector system.

Therefore, it would be desirable to provide a smoke/carbon monoxide detector system and apparatus for which maintenance and testing functions are easily accessed. It would further be desirable to provide a smoke/carbon monoxide detector in a package that is unobtrusive and easily installed during the construction of a new building. It would further be desirable to provide a smoke/carbon monoxide detector system having controls and batteries accessible by physically disabled and elderly persons.

### SUMMARY OF THE INVENTION

The above objective of accessible maintenance, unobtrusive packaging and ease of installation for a smoke/carbon monoxide detector system are achieved in an enhanced access combustion gas detector system and apparatus for installation in new construction of single and multi-family residential installations.

The system includes a ceiling mounted combustion gas detector that is installed inside the ceiling and includes an aperture for passing wires above the ceiling and within a wall to a wall mounted battery compartment where the backup battery is contained. The battery compartment may also include a test switch that is also wired to the ceiling mounted combustion gas detector by wires passing within the wall and above the ceiling, for activating the smoke detector from an easily accessible height in conformity with American Disabilities Act (ADA) requirements. The battery compartment may also include a battery charge indicator for indicating the charge state of the backup battery.

Additionally, the altering mechanism of the combustion gas detector may be a strobe light and/or the standard audible alarm and the strobe light may be located at the ceiling location, the battery compartment or within a separate wall mounted strobe light fixture for mounting on the wall at a height close to the ceiling where code requires and in conformity with American Disabilities Act (ADA) requirements.

Finally, the wall mounted battery compartment unit may serve multiple combustion gas detectors, containing the backup battery for each detector and optionally a battery charge indicator and test switch for each combustion gas detector unit.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram depicting an installed smoke/carbon monoxide detector system in accordance with an embodiment of the present invention.

FIGS. 2A and 2B are pictorial diagrams depicting a smoke/carbon monoxide detector in accordance with an embodiment of the present invention.

FIG. 3 is a pictorial diagram depicting a battery compartment in accordance with an embodiment of the present invention.

FIG. 4 is a pictorial diagram depicting a strobe light assembly in accordance with an embodiment of the present invention.

### DETAILED DESCRIPTION OF THE PREFERRED EMBODIMENTS

The present invention concerns a smoke/carbon monoxide detector system (combustion gas detector system) for permanent new single and multi-family residential installation in conformity with the American Disabilities Act (ADA). The ADA generally concerns the design of facilities so that where possible, a physically disabled or elderly person is not disadvantaged in their use and maintenance. Smoke/carbon monoxide detector and alarm systems generally are mounted at ceiling height and require periodic maintenance in that the backup batteries employed have a limited lifetime. When a person cannot reach the ceiling mounted alarm, they cannot replace the battery. Also, the test switches for testing the detector and alarm circuitry are typically mounted on the smoke/carbon monoxide detector housing. In most installations, a typical ceiling-mounted smoke/carbon monoxide detector can only be tested by a person using a ladder. For cathedral or high ceiling mounted smoke/carbon monoxide alarms, a ladder is generally required. The present invention provides an alternative to traditional smoke/carbon monoxide alarms in that all controls and maintenance requirements can be met at a height at which they can be accessed by a standing person or a person in a wheelchair.

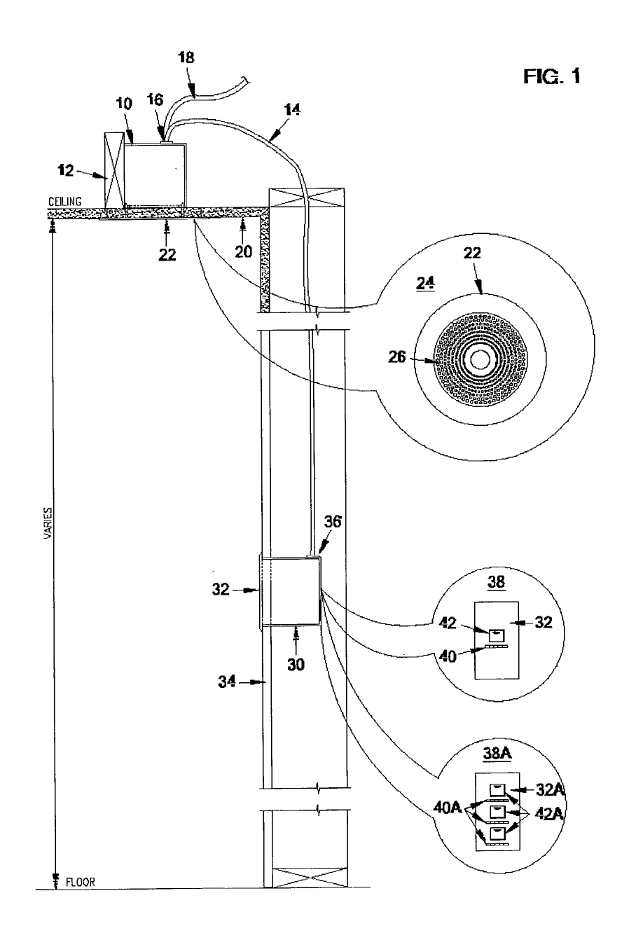

Referring now to the figures and in particular to FIG. 1, a smoke/carbon monoxide alarm system in accordance with an embodiment of the present invention is shown installed as a part of new residential construction. A smoke/carbon monoxide detector 10 is encased in a housing that conforms to the dimensions and code specification for a standard plastic or metal electrical wiring box. Smoke/carbon monoxide detector is shown affixed to a ceiling rafter or ceiling joist 12 (depending on ceiling type) and may provide nailing sheaths on the outside of the housing for insertion of mounting nails. Smoke/carbon monoxide detector 10 housing includes an opening or aperture 16 on the top side of the housing through which electrical wiring 14, 18 can be extended above the interior surface of ceiling 20 (which is generally wallboard), providing electrical connections that are hidden from view and potential damage. Aperture 16 may be a opening in the electrical wiring box, conduit fastening aperture or cable-clamp attachment aperture in conformity with the National Electric Code (NEC) or other code requirement, and one or both of electrical wiring 14 and/or 18 may be extended through the opening, conduit or clamped at aperture 16.

Smoke detector 10 also includes a cover 22, with details thereof shown in balloon 24. Cover 22 is shown as a round cover having perforations 26 for the entry of smoke/carbon monoxide, whereby smoke/carbon monoxide detector 10 can detect the presence of smoke/carbon monoxide gas via an internal detector. Cover 22 is generally a thin cover mounted to the housing of smoke/carbon monoxide detector 10, as all of the electronics of smoke/carbon monoxide detector as well as the alarm and detection device are located above the interior surface 20 of the ceiling. Perforations 26 also provide for the exit of sound from the smoke/carbon monoxide detector 10 housing if the alerting mechanism is an audible alarm mounted within smoke/carbon monoxide detector housing 10. Wiring 18 is connected to a household AC power supply circuit and to a power supply input of smoke/carbon monoxide detector 10 for supplying power to smoke/carbon monoxide detector 10 when power is available. Wiring 14 is connected to internal terminals of smoke/carbon monoxide detector 10 and provide connection to terminals for supplying battery backup power for operating smoke/carbon monoxide alarm in the absence of sufficient voltage at AC power supply wiring 18.

The smoke/carbon monoxide detector system of FIG. 1 also includes a wall mounted battery compartment 30 that is mounted at a height at or below 48 inches, as specified for access in compliance with the ADA. Battery compartment 30 includes a cover 32 generally conforming to standard wall-switch cover dimensions and may be detachably or hinge-mounted to battery compartment, whereby battery compartment 30 may be opened for replacing battery. Battery compartment 30 extends behind the interior surface 34 of the mounting wall and the housing of battery compartment 30 includes an opening or aperture 36 on the back side of a standard plastic or metal electrical wiring box. Electrical wiring 14 can thereby be extended through aperture 36 behind the interior surface 34 of the mounting wall (which is generally wallboard), providing electrical connections that are hidden from view and potential damage. Electrical wiring 14 extends from the battery connections of smoke/carbon monoxide detector 10 to the battery terminals of a battery installed within battery compartment 30. Electrical wiring 14 may also include connections from test connections of smoke/carbon monoxide detector 10 to terminals of a test switch within battery compartment 30.

Aperture 36 may be a opening in the electrical wiring box, a conduit fastening aperture or a cable-clamp attachment aperture in conformity with the National Electric Code (NEC) or other code requirement, and a portion of or all of electrical wiring 14 may be extended through the opening, conduit or clamped at aperture 36. Multiple apertures may be used to provide exit points for different portions of electrical wiring 14.

Details of cover 32 are shown in balloon 38. Cover 32 includes a test switch surface 42 permitting activation of a test switch coupled to smoke/carbon monoxide detector 10 test terminals via wiring 14. Cover also may include a battery charge state indicator 40 for indicating to a resident the state of the battery enclosed in battery compartment 30.

An alternative cover 32A for use with an alternative embodiment of the invention is depicted in balloon 38A. Multiple test switches 42A for activating multiple smoke/carbon monoxide detectors 10 are included on the face of cover 30A and multiple battery charge state indicators 40A are included to indicate the state of multiple batteries installed within battery compartment 30. Alternative cover 32A is used with an associated alternative battery compartment containing multiple batteries and wiring 14 includes connections to multiple smoke/carbon monoxide detectors 10, so that the each test switch 42A has terminals connected to test connections of an associated smoke/carbon monoxide detector 10, each battery has terminals connected to battery connections of the associated smoke/carbon monoxide detector 10 and each battery charge state indicators 40A are coupled to an associated battery to show the state of the battery associated with a particular smoke/carbon monoxide detector 10.

An alternative embodiment of the present invention includes a strobe light subsystem to provide a visible indication of an alarm condition at smoke/carbon monoxide detector 10 to persons who have a hearing disability. The strobe light subsystem (or the strobe light itself with driver electronics located within the smoke/carbon monoxide detector 10, although that is not generally desirable due to the high voltages present) may be located either in the smoke/carbon monoxide detector 10, the wall mounted battery compartment 30 or a separate strobe light housing including a strobe light subsystem having an electrical connection to smoke/carbon monoxide detector 10 for activating the strobe light in response to an alarm condition.

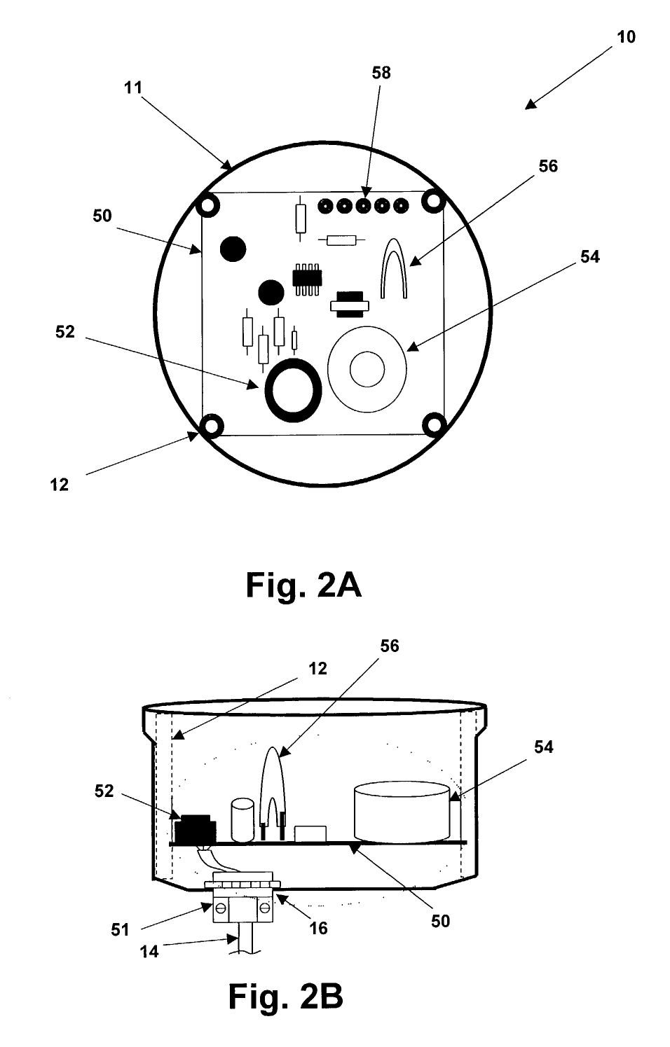

Referring now to FIGS. 2A and 2B, a smoke/carbon monoxide detector 10 in accordance with an embodiment of the invention is depicted. Smoke/carbon monoxide detector 10 includes a housing 11 in a shape conforming to a standard deep plastic or metal octagon box, and composed of materials suitable for electrical box applications. Mounting holes 12 are provided for the attachment of cover 22 and also can be molded to secure within housing 11, a printed circuit board 50 on which various electronic components are mounted. A detector unit 54 provides detection of smoke/carbon monoxide, an audible alarm 52 (generally a piezoelectric element) and optionally a strobe light 56 are mounted on printed circuit board 50, which includes components of a strobe light subsystem, such as a high voltage transformer. Note: if a strobe light is included with housing 11, a transparent window will generally be required in cover 22, although perforations 26 may provide sufficient transmission of light.

Battery, test switch, battery charge state indicator and external strobe light connections 58 are provided on printed circuit board 50 and may take the form of a connector whereby wiring 14 may be detached. Wires 18 are not shown in FIGS. 2A and 2B, but may be provided through a second aperture or may be introduced through aperture 16, depending on code requirements. Wires 18 may also be provided as stubs protruding through housing 11, providing an AC connection that does not require internal connection within housing 11. Within aperture 16 an cable clamp 51 is installed to secure wiring 14, but conduit connectors can be used for conduit applications, or an attachment device may not be required, depending on installation requirements. Alternatively, wiring may be molded through housing, or a rubber grommet used.

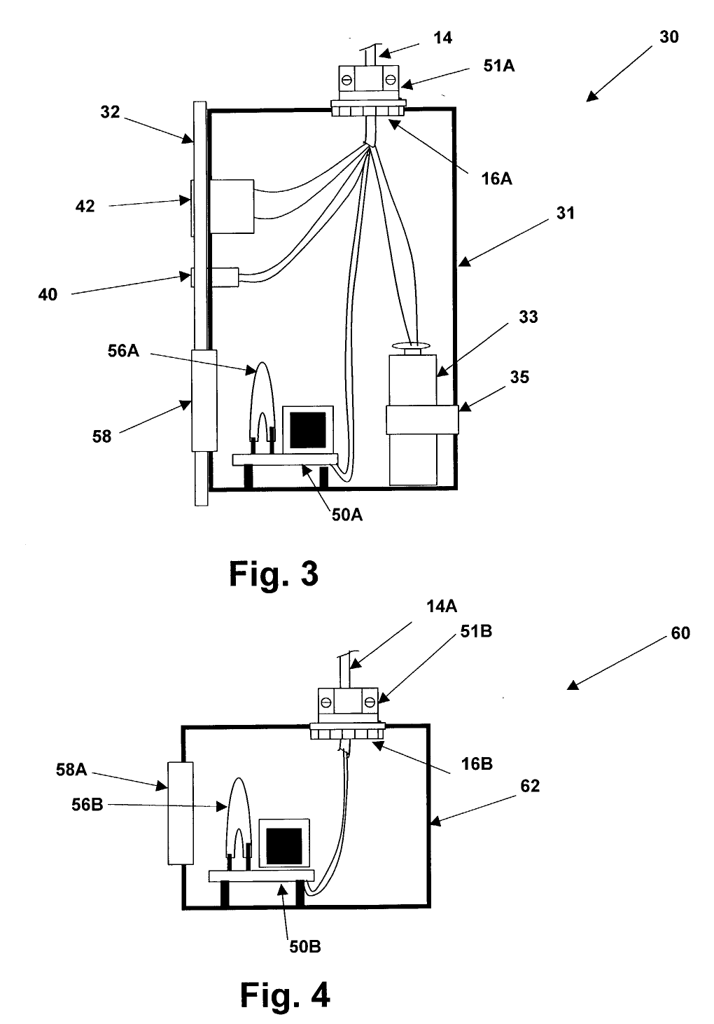

Referring now to FIG. 3, a battery compartment 30 in accordance with an embodiment of the present invention is shown. Battery compartment includes a housing 31 conforming to the dimensions as a plastic electrical switch box and fabricated from a material suitable thereto, and a cover 32 also formed with dimensions and a material similar to a standard switch box cover plate. Cover 32 provides mounting for test switch 42, battery charge state indicator 40 and optionally a transparent window 58 if battery compartment includes a strobe light 56A. A strobe light subsystem may be mounted on a printed circuit board 50A within housing 31. A cable clamp 51A is mounted through an aperture 16A in housing 31 for securing wiring 14. Alternatively, a conduit connector or wiring grommet may be used or an attachment device may not be required, depending on installation requirements.

A battery 33 is mounted to housing 31 by a battery clamp 35 and has terminals connected to wiring 14 by battery connector 37. Test switch 42, battery charge state indicator 40 and strobe light subsystem 50A are also connected via wiring to smoke/carbon monoxide detector 10.

Referring now to FIG. 4, a strobe light assembly 60 in accordance with an embodiment of the present invention is depicted. Strobe light assembly includes a housing 62 including a transparent window 58A and is depicted as a housing 62 that may be mounted within a wall, whereby window 58A is set flush to or slightly beyond the surface of the wall. A cable clamp 51B is mounted through an aperture 16B in housing, whereby wiring 14A is extended to smoke detector 10 terminals 58. A strobe light subsystem 50B is provided, including a strobe light 56B, for activation in response to a smoke/carbon monoxide detector alarm condition.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A physical disability accessible combustion gas detector system, comprising:
a ceiling mounted combustion gas detector device, having a first aperture located above a surface of said ceiling for extending leads from battery connections of internal circuits of said combustion gas detector device above the interior surface of the ceiling;
a wall mounted battery compartment having a second aperture located behind the interior surface of the mounting wall for extending leads behind the mounting wall from terminals of a battery contained within the battery compartment; and
wires connecting said battery terminals with said battery connections and extending above said interior surfaces of the ceiling and the mounting wall by extending through said first aperture and said second aperture.

2. The system of claim 1, wherein said first aperture and said second aperture are conduit fittings, and further comprising a conduit extending from said first aperture to said second aperture, and wherein said wires are encased within said conduit.

3. The system of claim 1, wherein said ceiling mounted combustion gas detector comprises a housing adapted to conform to the shape of a standard deep octagon electrical box, whereby said internal circuits of said combustion gas detector are located above said interior surface of said ceiling.

4. The system of claim 3, further comprising a perforated cover attached to said housing for covering said housing after said combustion gas detector device is installed in said ceiling.

5. The system of claim 1, wherein said wall mounted battery compartment further comprises a test switch having an activating surface accessible from a face of said battery compartment, wherein said wires further comprise at least one wire connected from said test switch to said internal circuits of said combustion gas detector device, whereby said combustion gas detector device may be tested by activating said test switch.

6. The system of claim 1, further comprising a battery charge level indicator visible from a face of said battery compartment, whereby a condition of said battery may be observed from said battery compartment.

7. The system of claim 1, further comprising a strobe light subsystem mounted within said battery compartment and visible from a face of said battery compartment, and wherein said plurality of wires further comprise wires for coupling said strobe light subsystem to said internal circuits of said combustion gas detector device, whereby said strobe light may be activated in response to activation of said combustion gas detector device.

8. The system of claim 1, further comprising a strobe light subsystem mounted within said ceiling mounted combustion gas detector device and visible from a face of said combustion gas detector device, and wherein said strobe light subsystem is to said internal circuits of said combustion gas detector device, whereby said strobe light may be activated in response to activation of said combustion gas detector device.

9. The system of claim 1, further comprising a wall mounted strobe light subsystem for mounting at a height greater than a height of said battery compartment and having a third aperture located behind the interior surface of the mounting wall for extending leads from said strobe light subsystem behind said interior surface of said wall, and wherein said wires further comprise wires for coupling said strobe light subsystem to said internal circuits of said combustion gas detector device, whereby said strobe light may be activated in response to activation of said combustion gas detector device.

10. The system of claim 1, wherein said ceiling mounted combustion gas detector device comprises multiple ceiling mounted combustion gas detector devices, each having a first aperture located above a surface of said ceiling for extending leads from battery connections of internal circuits of said combustion gas detector devices above the interior surface of the ceiling;
a wall mounted battery compartment having a second aperture located behind the interior surface of the mounting wall for extending leads behind the mounting wall from terminals of multiple batteries contained within the battery compartment; and
wires connecting said battery terminals of each battery with said battery connections of a corresponding smoke detector device and extending above said interior surfaces of the ceiling and the mounting wall by extending through said first aperture of the corresponding combustion gas detector device and said second aperture.

11. A physical disability accessible combustion gas detector system, comprising:
a ceiling mounted combustion gas detector device;
a wall mounted battery compartment; and
means for passing wires from said combustion gas detector device to said battery compartment, wherein said wires are contained behind the interior surfaces of said ceiling and said wall.

12. A combustion gas detector, comprising:
a detection device for detecting the presence of combustion gas particles in the air within a residence;
an alerting mechanism coupled to said detection device for alerting an occupant of said residence that said particles are present; and
a housing containing said detection device and said alerting mechanism, wherein said housing is mountable above an interior surface of a ceiling of said residence.

13. The combustion gas detector of claim 12, wherein said housing is adapted to conform to the shape of a standard deep octagon electrical box.

14. The combustion gas detector of claim 12, further comprising a perforated cover attached to said housing for covering said housing after said combustion gas detector is installed in said ceiling.

15. The combustion gas detector of claim 12, wherein said housing defines at least one conduit attachment aperture.

16. The combustion gas detector of claim 12, wherein said detection device comprises terminals for connection of wires from an external battery.

17. The combustion gas detector of claim 12, wherein said alerting mechanism comprises terminals for connection of wires to an external strobe light subsystem.

18. The combustion gas detector of claim 12, wherein said detection device comprises terminals for connection of wires to an external battery charge indicator.

19. The combustion gas detector of claim 12, wherein said alerting device comprises an audible alarm.

20. The combustion gas detector of claim 12, wherein said alerting device comprises a strobe light subsystem.
